(19) United States
(12) Patent Application Publication
(10) Pub. No.: US 2015/0030386 A1
(43) Pub. Date: Jan. 29, 2015

(54) TRACK MOUNT BASE WITH MOMENTARY RELEASE

(71) Applicant: Jeffrey D. Carnevali, Seattle, WA (US)

(72) Inventor: Jeffrey D. Carnevali, Seattle, WA (US)

(21) Appl. No.: 13/952,637

(22) Filed: Jul. 28, 2013

(51) Int. Cl. F16B 21/02

(52) U.S. Cl. CPC F16B 21/02
USPC 403/348

(57) ABSTRACT

A locking rail base, formed of a case having a shell formed with a hollow cavity with an opening thereinto, a stabilizer, and a passage through an end of the shell; a T-bolt anchor having a shank with flukes adjacent one end; and a T-bolt cylinder received into the cavity in the shell, the T-bolt cylinder forming a channel having the shank of the T-bolt anchor received slidingly therein. An anti-rotation interface is provided between the shank of the T-bolt anchor and the channel of the T-bolt cylinder. A drive interface is provided between an actuator and a portion of the T-bolt shank. An anti-actuation interface is provided between the actuator and the T-bolt cylinder; and a momentary release mechanism is provided for momentarily releasing the anti-actuation interface between the actuator and the T-bolt cylinder.

### FIELD OF THE INVENTION

The present invention relates generally to T-clamps for connecting to a T-slot, and in particular to T-clamps having a momentary release mechanism.

### BACKGROUND OF THE INVENTION

T-clamps for connecting to a T-slot are generally well-known. However, known T-clamps are limited in their ability to efficiently provide quick and reliable interlocking with a T-slot, as well as momentary releasing and moving to different locations along the T-slot.

Accordingly, there exists a need for a T-clamp having an efficient assembly and interlocking mechanism, as well as a quick and easy momentary releasing mechanism.

### SUMMARY OF THE INVENTION

The present invention is a novel quick release locking rail base having an efficient assembly and interlocking mechanism, as well as a quick and easy momentary releasing mechanism.

According to one aspect of the invention the novel quick release locking rail base, formed of a case having a shell formed with a hollow cavity with an opening thereinto, a stabilizer, and a passage through an end of the shell; a T-bolt anchor having a shank with flukes adjacent one end; and a T-bolt cylinder received into the cavity in the shell, the T-bolt cylinder forming a channel having the shank of the T-bolt anchor received slidingly therein. An anti-rotation interface is provided between the shank of the T-bolt anchor and the channel of the T-bolt cylinder. A drive interface is provided between an actuator and a portion of the T-bolt shank. A directional anti-rotation interface is provided between the actuator and the T-bolt cylinder; and a momentary release mechanism is provided for momentarily releasing the directional anti-rotation interface between the actuator and the T-bolt cylinder.

Other aspects of the invention are detailed herein.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a perspective view showing an example of the novel track mount for operation with a conventional T-slot;

FIG. 2 is another perspective view showing an example of the novel track mount of FIG. 1 having spaced-apart stabilizers projected from a base thereof;

FIG. 3 is another perspective view showing an example of the novel track mount of FIG. 1 installed on the mounting surface of a conventional T-slot with the stabilizers extended through an opening between the spaced apart T-rails;

FIG. 4 and FIG. 5 show the novel track mount of FIG. 1 installed on mounting surfaces of different T-slots with flukes of a T-bolt anchor of the device received between the opposing T-rails into respective T-slot cavities, wherein the openings between the spaced apart T-rails and the respective T-slot cavities are differently sized between FIGS. 4 and 5;

FIG. 6 is a cross-section showing the novel track mount of FIG. 1 installed on the mounting surface of the T-slot with the flukes of the T-bolt anchor received between the opposing T-rails and clamped therewith;

FIG. 7 is another cross-section that illustrates assembly of the novel track mount of FIG. 1;

FIG. 8 is another cross-section that illustrates assembly of the novel track mount of FIG. 1 showing a drive actuator rotationally interfaced with an exterior surface of the T-clamp case shell, wherein the drive actuator is operated by turning of the drive actuator which in turn operates a drive mechanism between the drive actuator and the T-bolt anchor for drawing the T-bolt anchor into the case shell of the track mount assembly; and wherein a detent-type anti-actuation interface is illustrated;

FIG. 9 is another cross-section that illustrates assembly of the novel track mount of FIG. 1 that illustrates a ratchet design of the detent-type anti-actuation interface; and

FIG. 10 and FIG. 11 are lengthwise cross-sections of the novel track mount of FIG. 1 that illustrate the track mount assembly being tightly seated on the surface of the T-slot, wherein FIG. 10 illustrates the anti-actuation interface being actuated for rotationally fixing the drive actuator relative to the device case shell, and FIG. 11 illustrates the anti-actuation interface being momentarily released.

### DETAILED DESCRIPTION OF PREFERRED EMBODIMENT

In the Figures, like numerals indicate like elements.

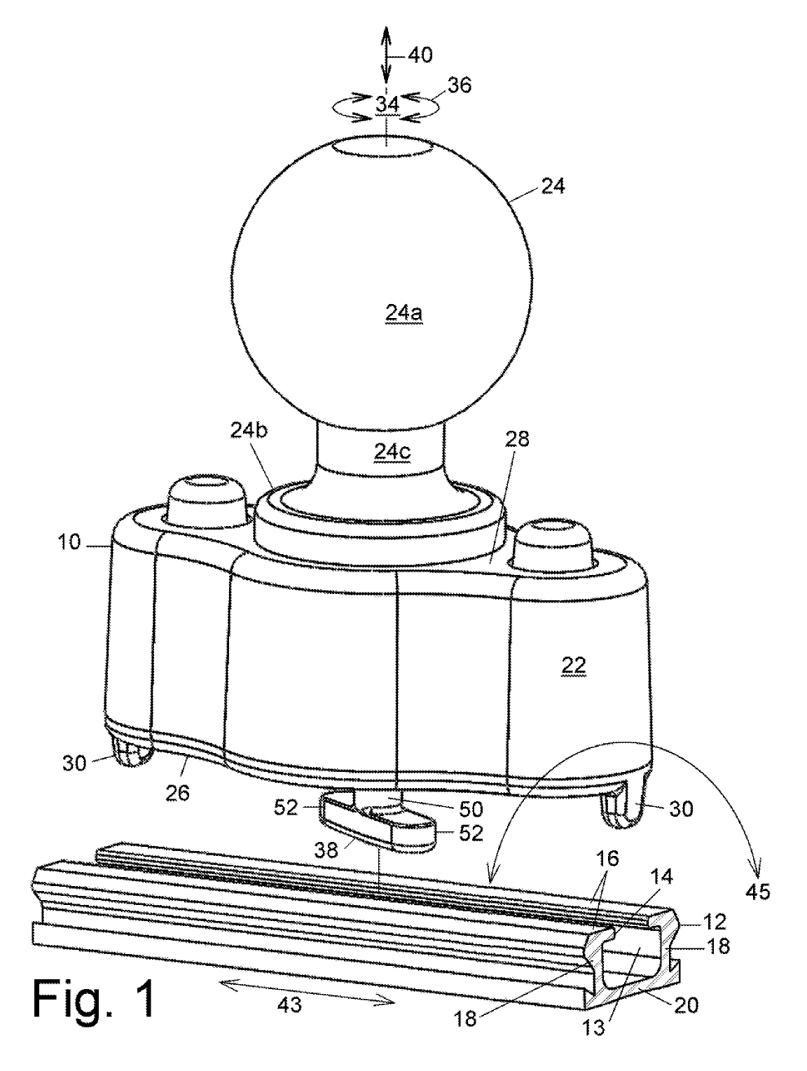

FIG. 1 illustrates one embodiment of a novel track mount 10 for operation with a conventional T-slot 12 formed in a rail (shown) or other plate. T-slot channel 12 is formed as a that has an opening 14 to a mounting surface 16 formed between opposing spaced apart T-rails 18 spread out from a wide base 20.

Track mount 10 includes a case shell 22 molded of a substantially rigid material, for example, an injection moldable plastic, composite or metal material, and having a mount 24 projected therefrom. Case shell 22 of track mount 10 is formed with a substantially planar base 26 and a crown 28 spaced away from base 26. A pair of stabilizers 30 is spaced apart along base 26 of T-clamp case shell 22 and is sized to be received through opening 14 into T-slot 12 between spaced apart T-rails 18. Stabilizers 30 operate for rotationally fixing case shell 22 relative to opening 14 in T-slot channel 12. Optionally, pair of stabilizers 30 may extend nearly to base 20 of T-slot 12. T-clamp case shell 22 is further formed with an axial bore or aperture 32 communicating through its crown 28 along an operational axis 34 passing between pair of stabilizers 30 of case shell 22.

By example and without limitation, mount 24 is optionally a ball-end mount or “coupler” of the type disclosed by Jeffrey D. Carnevali, the inventor of the present T-clamp device 10, in U.S. Pat. No. 5,845,885, entitled “Universally Positionable Mounting Device,” issued Dec. 8, 1998, the complete disclosure of which is incorporated herein by reference. For example, when formed as a coupler, mount or coupler 24 is optionally formed having a substantially smooth, part-spherical head member 24a of a pressure deformable, resilient elastomeric material, which renders the part-spherical head member 24a relatively resiliently radially compressible. Alternatively, the part-spherical head 24a is formed of a substantially rigid material and having a plurality of discrete triangular surfaces as disclosed by example and without limitation in U.S. Pat. No. 6,581,892, entitled “Geodesic Mounting Apparatus,” issued to Jeffrey D. Carnevali, the inventor of the present T-clamp device 10, on Jun. 24, 2003, the complete disclosure of which is incorporated herein by reference. Other mount structures, such as pins, rods or plates as well as proprietary structures, are also contemplated and are considered equivalent structures and are substituted for mount or coupler 24 without departing from the scope and intent of the invention.

Mount or coupler 24 optionally includes a base member 24b that rotationally interfaces with exterior surface of T-clamp case shell 22 adjacent to crown 28 thereof. Part-spherical head member 24a is presented on a short stem or neck member 24c projected from base member 24b.

Mount or coupler 24 is coupled for rotational motion (arrow 36) thereof about axis 34.

A substantially rigid T-bolt anchor 38 is extended through T-clamp case shell 22 and passing between pair of stabilizers 30 thereof. T-bolt anchor 38 is rotationally fixed relative to axis 34, and is coupled only for linear translation (arrow 40) along axis 34 responsively to operation of a drive mechanism 44. For example, T-bolt anchor 38 is responsive to rotational motion (arrow 36) of a drive actuator rotated about operational axis 34. The rotational motion (arrow 36) about axis 34 of the drive actuator results in linear translation (arrow 40) of anchor 38 along same axis 34. For example, coupler 24 or a rotatable portion thereof optionally operates as the drive actuator.

Anchor 38 is shown as a T-bolt formed with a shank 50 extended substantially along axis 34. One or two flukes 52 are rigidly extended outwardly from shank 50 substantially crosswise of axis 34 in positions external of T-clamp case shell 22 and substantially diametrically opposite one from the other. Each fluke 52 is sized to be received into T-slot 12 through opening 14 and into opposing T-rails 18 on either side of T-slot base 20. Flukes 52 are movable only in linear translation (arrow 40) substantially along axis 34 responsive to rotation (arrow 36) of drive actuator (coupler 24) about axis 34. Rotation (arrow 36) of drive actuator (coupler 24) causes linear translation (arrow 40) of flukes 52 relatively toward and away from base 26 of T-clamp case shell 22 as a function of linear translation (arrow 40) of anchor 38 along axis 34.

During installation and removal of track mount 10, each fluke 52 is fixed in an interlocking configuration (shown) that is angularly oriented between pair of stabilizers 30 on base 26 of T-clamp case shell 22. With flukes 52 of T-bolt anchor 38 oriented along opening 14 between T-rails 18, T-bolt anchor 38 is first inserted into opening 14 until flukes 52 are in space between T-rails 18. Track mount 10 is then rotated relative to T-slot channel 12 until stabilizers 30 are aligned with opening 14 between T-rails 18. Track mount 10 is then moved toward T-slot channel 12 until stabilizers 30 are within opening 14 between T-rails 18. At this point, flukes 52 of T-bolt anchor 38 are within space below mounting surface 16 and positioned adjacent to base 20 of T-slot channel 12. Drive actuator (coupler 24) is then operated for rotational motion (arrow 36) thereof about axis 34 to draw T-bolt anchor 38 in linear translation (arrow 40) along to axis 34 until flukes 52 contact undersides of mounting surface 16, and case shell 22 of track mount 10 is compressed against T-slot channel 12 in frictional contact with mounting surface 16. Thereafter, mount 24 of track mount 10 can be used without sliding motion (arrow 43) along opening 14 of T-slot channel 12. Compression of case shell 22 against T-slot channel 12 also protects against swaying or rocking motion (arrow 45) of track mount 10 crosswise of T-slot channel 12.

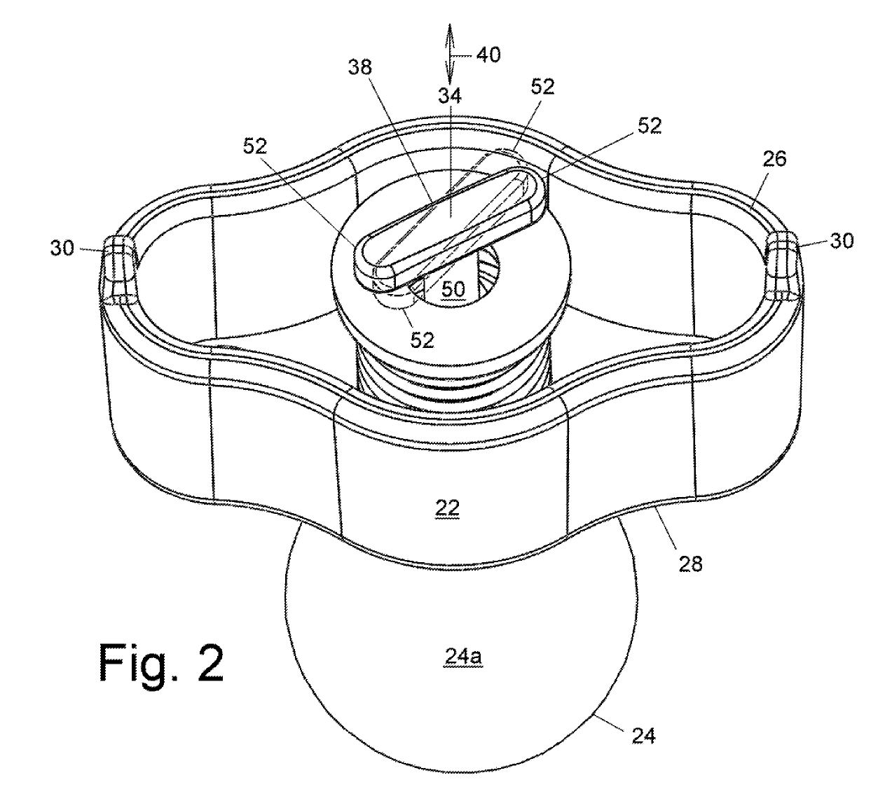

FIG. 2 shows case shell 22 of track mount 10 having spaced-apart stabilizers 30 projected from base 26 thereof.

As disclosed herein, T-bolt anchor 38 rotationally fixed relative to axis 34. However, T-bolt anchor 38 angularly repositionable relative to axis 34, whereby flukes 52 are fixed in either a first interlocking configuration (shown) or a different second interlocking configuration (phantom) that is angularly oriented relative to axis 34 differently than flukes 52 in the first interlocking configuration. Flukes 52 of T-bolt anchor 38 are thus angularly repositionable between at least two different first and second interlocking configurations, wherein flukes 52 in each of the first and second interlocking configurations are angularly oriented differently relative to axis 34 and case shell 22 of track mount 10.

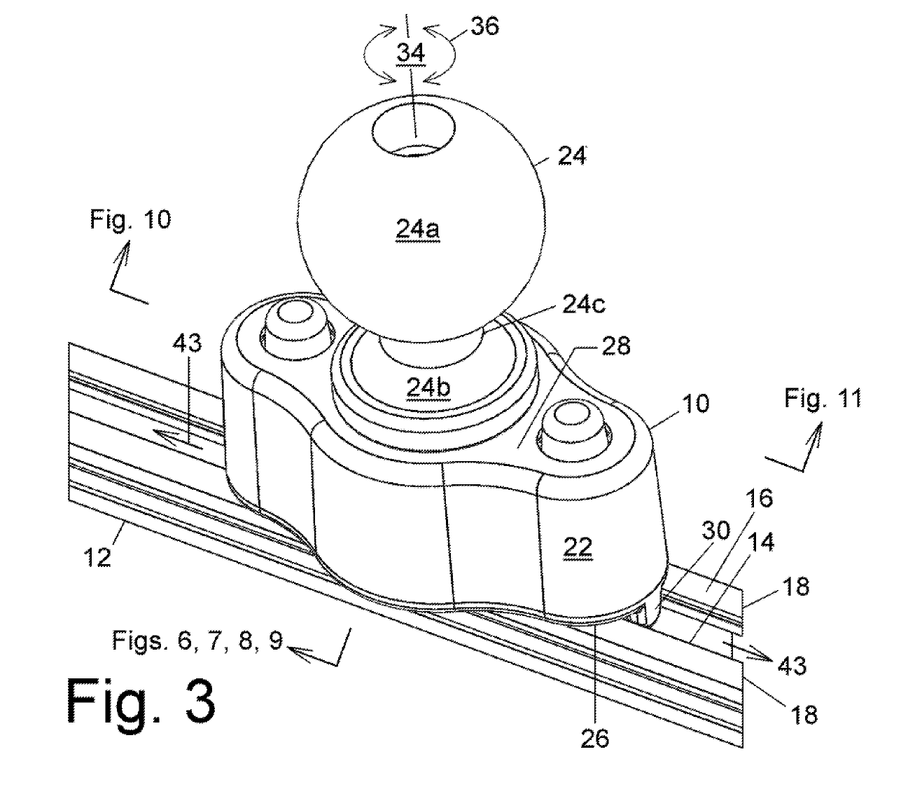

FIG. 3 illustrates track mount 10 installed on mounting surface 16 of T-slot 12 with stabilizers 30 on case shell 22 extended through opening 14 between spaced apart T-rails 18. As disclosed herein, track mount 10 is alternately positionally fixed relative to T-slot 12, and linearly movable (arrows 43) along mounting surface 16 with stabilizers 30 on case shell 22 positioned in opening 14 between spaced-apart T-rails 18, as a function of the clamping position of T-bolt anchor 38 relative to base 26 of case shell 22 as determined by operation of drive actuator (coupler 24).

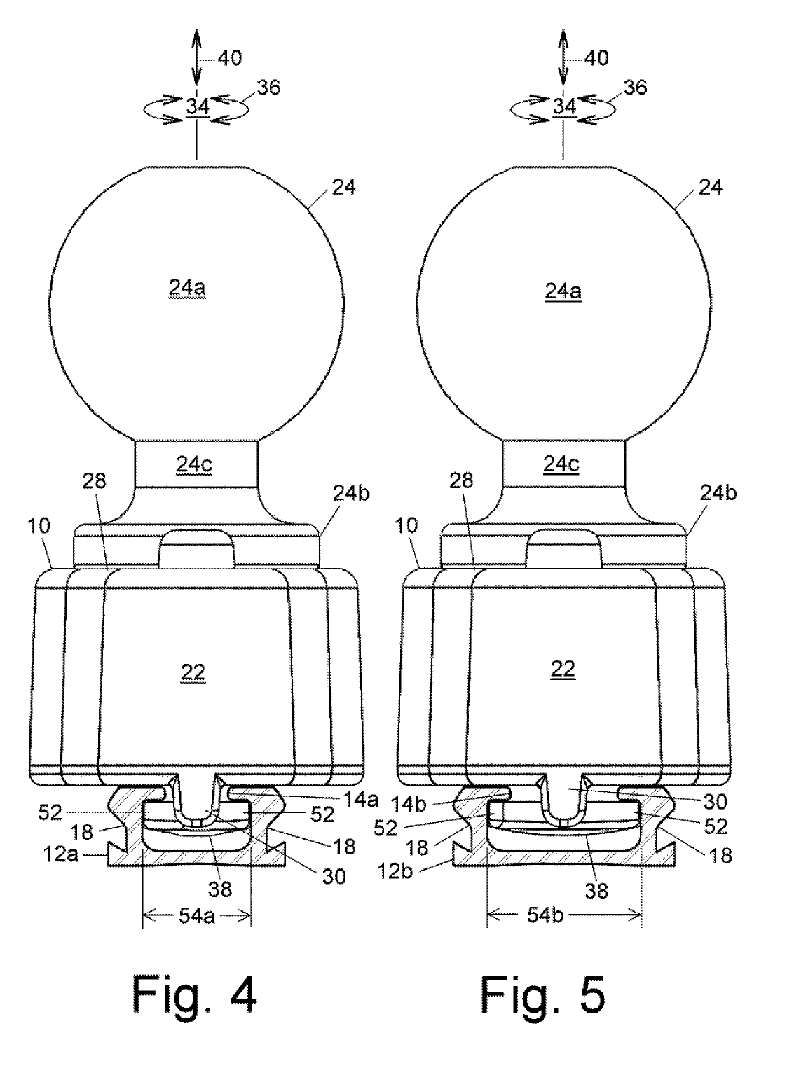

FIG. 4 and FIG. 5 show track mount 10 installed on mounting surface 16 of T-slot 12 with flukes 52 of T-bolt anchor 38 received between opposing T-rails 18 into T-slot cavity 13. As illustrated here and disclosed more fully herein, T-bolt anchor 38 is adaptable for clamping in different T-slots 12a and 12b having different narrower (FIG. 4) and wider (FIG. 5) spacings 54a and 54b between opposing T-rails 18, as well as different narrower openings 14a (FIG. 4) and wider openings 14b (FIG. 5) therebetween.

FIG. 4 shows flukes 52 of T-bolt anchor 38 rotationally fixed in the first interlocking configuration that is angularly oriented relative to axis 34. Accordingly, track mount 10 is installed in narrow T-slot 12a having narrower spacing 54a between opposing T-rails 18.

FIG. 5 shows flukes 52 of T-bolt anchor 38 rotationally fixed in the second interlocking configuration that is angularly oriented relative to axis 34 differently from flukes 52 in the first interlocking configuration. Accordingly, track mount 10 is installed in wide T-slot 12b having wider spacing 54b between opposing T-rails 18.

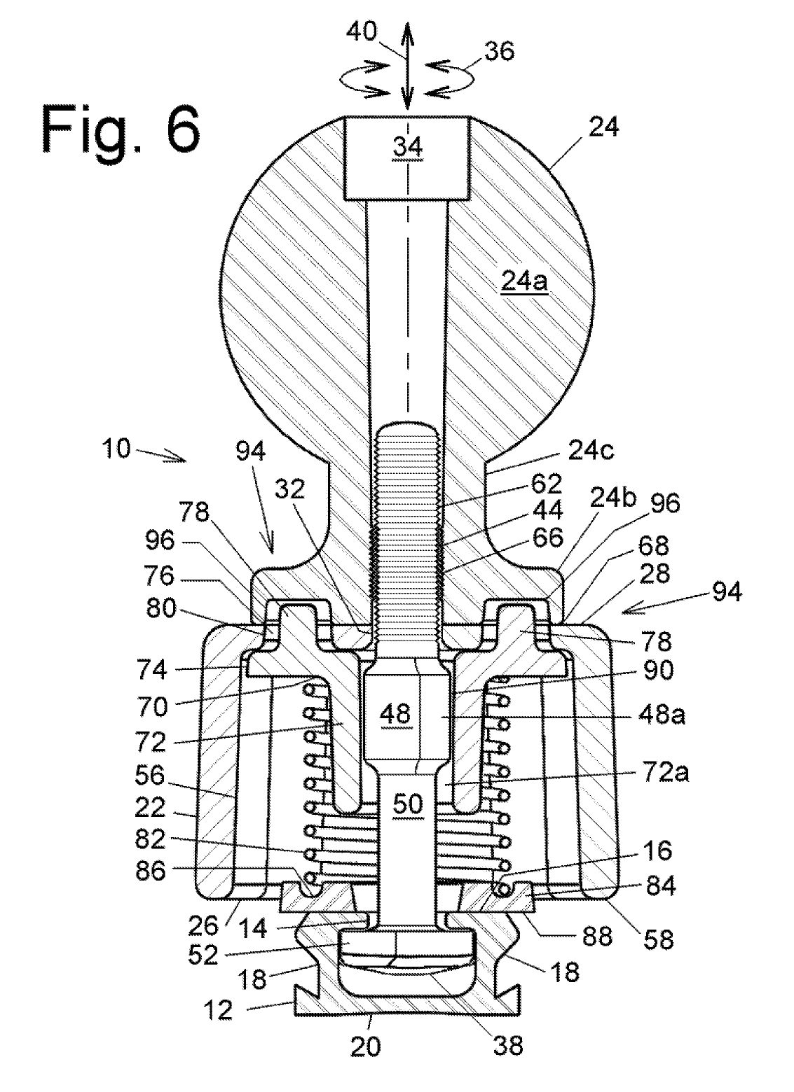

FIG. 6 is a cross-section of track mount 10.

Internally, case shell 22 is formed with a cavity 56 that is substantially hollow between base 26 and crown 28 thereof. Base 26 of case shell 22 is formed with an opening 58 thereinto having pair of stabilizers 30 spaced apart adjacent to opposite ends thereof. Crown 28 of case shell 22 is formed with axial bore or aperture 32 communicating therethrough along an operational axis 34 central thereof opposite of opening 58.

Anchor 38 is shown as a T-bolt formed with a stock portion 48 having smaller shank 50 extended therefrom substantially along axis 34. One or more flukes 52 are rigidly extended outwardly from shank 50 substantially crosswise of axis 34 in positions external of T-clamp case shell 22 and substantially diametrically opposite one from the other, as disclosed herein. Stock portion 48 of T-bolt anchor 38 is further formed with a second shank 62 extended therefrom opposite of shank 50 and flukes 52.

FIG. 6 shows internal mechanism for controlling T-bolt anchor 38. A T-bolt cylinder 70 is positioned within cavity 56 in T-clamp case shell 22 and slidingly movable in linear translation (arrow 40) substantially along axis 34. T-bolt cylinder 70 is formed with a control channel 72. An alignment portion 74 of T-bolt cylinder 70 is structured for locating control channel 72 substantially aligned with axial bore or aperture 32 through crown 28 of case shell 22 along operational axis 34. For example but without limitation, alignment portion 74 of T-bolt cylinder 70 is structured as a shoulder or flange surrounding one end of control channel 72 and positioned adjacent to crown 28 of case shell 22. T-bolt cylinder 70 is substantially rotationally immovable about axis 34 relative to case shell 22. For example, an anti-rotation interface 76 is operational between T-bolt cylinder 70 and case shell 22. By example and without limitation, anti-rotation interface 76 includes one or a plurality of detents formed between T-bolt cylinder 70 and case shell 22. For example, such detent-type anti-rotation interface 76 optionally includes one or more mating teeth 78 and receivers 80 distributed between T-bolt cylinder 70 and case shell 22. It will be understood that mating teeth 78 and receivers 80 are optionally distributed on either of T-bolt cylinder 70 and case shell 22. It also will be understood that different anti-rotation interfaces 76 between T-bolt cylinder 70 and case shell 22 are also contemplated and may be included and/or substituted without deviating from the scope and intent of the present invention. For example, mating non-round shapes of T-bolt cylinder 70 and case shell 22 are present in track mount 10, as disclosed herein, and are optionally relied upon for operating as anti-rotation interface 76. In another example, depressors 106 of momentary release mechanism 100 extended through corresponding apertures 104 in crown 28 of T-clamp case shell 22 are optionally relied upon for operating as anti-rotation interface 76.

However, T-bolt cylinder 70 is movable in linear translation (arrow 40) substantially along axis 34 relative to case shell 22 for moving toward or away from crown 28 thereof. Anti-rotation interface 76 includes a biasing member 82 adapted for depressibly biasing at least alignment flange 74 of T-bolt cylinder 70 toward contact with crown 28 of case shell 22 for engaging mating teeth 78 and receivers 80 thereof. Biasing member 82 is, by example and without limitation, a conventional compression spring, for example, fitted about exterior of control channel 72. Optionally, anti-rotation interface 76 includes a bedding member 84 adapted for supporting one end of biasing member 82 opposite from alignment flange 74 of T-bolt cylinder 70. For example, bedding member 84 is formed as an annular ring or washer with a recess 86 on one side for receiving the coils of spring member 82, and a flat and smooth sliding surface 88 on the opposite side from recess 86 for resting against mounting surface 16 of T-slot channel 12 across opening 14 between spaced-apart T-rails 18 and sliding therealong as disclosed herein.

Control channel 72 of T-bolt cylinder 70 is sized to receive stock portion 48 of T-bolt anchor 38 slidingly therethrough, as well as second shank 62 thereof. An anti-rotation interface 90 is provided between stock portion 48 of T-bolt anchor 38 and control channel 72 of T-bolt cylinder 70, whereby T-bolt anchor 38 is substantially rotationally fixed and immovable about axis 34 relative to T-bolt cylinder 70. By example and without limitation, anti-rotation interface 90 is formed by mating non-round surfaces of stock portion 48 of T-bolt anchor 38 and control channel 72 of T-bolt cylinder 70. For example, external surface 48a of stock portion 48 of T-bolt anchor 38 and internal surface 72a of control channel 72 of T-bolt cylinder 70 are formed with mating substantially rectangular (shown) or other non-round cross-sections. Optionally, different anti-rotation interfaces 90 between T-bolt anchor 38 and T-bolt cylinder 70 may include, but are not limited to, mating hexagonal shapes, mating octagonal shapes, mating X-shapes, mating spline shapes, and mating oval shapes. Alternatively, anti-rotation interface 90 is optionally a keyway and mating key distributed between T-bolt anchor 38 and T-bolt cylinder 70. Therefore, it will be understood that different anti-rotation interfaces 90 between T-bolt anchor 38 and T-bolt cylinder 70 are also contemplated and may be included and/or substituted without deviating from the scope and intent of the present invention.

When mating external surface 48a of stock portion 48 of T-bolt anchor 38 and internal surface 72a of control channel 72 of T-bolt cylinder 70 are substantially square or other rectangular or non-round mating shapes, the different fixed angular orientations of first and second interlocking configurations of T-bolt anchor 38 are optionally accomplished by an angularly offset orientation of flukes 52 relative to stock portion 48. Accordingly, installing T-bolt anchor 38 with stock portion 48 in a first angular orientation relative to control channel 72 of T-bolt cylinder 70 causes flukes 52 to be fixed in a first angular orientation relative to case shell 22 of track mount 10, for example, whereby flukes 52 of T-bolt anchor 38 rotationally fixed in the first narrower interlocking configuration relative to axis 34. Furthermore, installing T-bolt anchor 38 with stock portion 48 in a second different angular orientation relative to control channel 72 of T-bolt cylinder 70, for example 90 degrees from the first angular orientation, causes flukes 52 to be fixed in a second different angular orientation relative to case shell 22 of track mount 10, for example, whereby flukes 52 of T-bolt anchor 38 rotationally fixed in the second wider interlocking configuration relative to axis 34.

It will be understood that increasing the offset of the angular orientation between flukes 52 and stock portion 48 will increase the difference in angular orientation between the first and second interlocking configurations of T-bolt anchor 38, whereby track mount 10 can accommodate greater extremes in width between narrow T-slot 12a and wide T-slot 12b by accommodating greater extremes between narrower spacing 54a and wider spacing 54b between opposing T-rails 18.

It will be further understood that decreasing the offset of the angular orientation between flukes 52 and stock portion 48 will decrease the difference in angular orientation between the first and second interlocking configurations of T-bolt anchor 38, whereby track mount 10 can accommodate only lesser extremes in width between narrow T-slot 12a and wide T-slot 12b by accommodating only lesser extremes between narrower spacing 54a and wider spacing 54b between opposing T-rails 18.

Furthermore, it will be understood that forming external surface 48a of stock portion 48 of T-bolt anchor 38 and internal surface 72a of control channel 72 of T-bolt cylinder 70 with mating substantially rectangular shapes will permit only two different fixed angular orientations of first and second interlocking configurations of T-bolt anchor 38 about axis 34. However, any three-point, five-point, six-point, eight-point or twelve-point or sixteen-point star shape of internal surface 72a of control channel 72 permits additional different fixed angular orientations of first and second interlocking configurations of T-bolt anchor 38 about axis 34.

Additionally, it will be understood that other non-round cross-sections having additional facets, such as hexagonal or octagonal cross-sections, will permit additional different fixed angular orientations of T-bolt anchor 38 about axis 34, whereby other interlocking configurations will be provided in addition to the first and second interlocking configurations disclosed herein. Therefore, it will be understood that different anti-rotation interfaces 90 between T-bolt anchor 38 and T-bolt cylinder 70 are also contemplated and may be included and/or substituted without deviating from the scope and intent of the present invention.

FIG. 6 also illustrates one embodiment of drive mechanism 44. Here, mount or coupler actuator 24 is adapted for driving T-bolt anchor 38 linearly along axis 34, for example, in response to rotation (arrow 36) of coupler actuator 24 about axis 34. For example, drive mechanism 44 is formed between coupler 24 and T-bolt anchor 38. By example and without limitation, drive mechanism 44 is formed as a threaded joint, wherein shank 62 of T-bolt anchor 38 is at least partially threaded, and an internal bore 66 of coupler 24 is at least partially threaded to match threaded portion of shank 62 for forming drive mechanism 44 as a threaded joint therebetween. Accordingly, when coupler actuator 24 is rotated (arrow 36) about axis 34, an interface surface 68 thereof operates against crown 28 of case shell 22 for driving linear translation (arrow 40) T-bolt anchor 38 responsively along axis 34.

In operation of drive mechanism 44, when coupler actuator 24 is rotated (arrow 36) in a first clamping direction, flukes 52 of anchor 38 are thereby forced in linear translation (arrow 40) along axis 34 into clamping contact with T-rails 18 of T-slot channel 12 for clamping base 26 of case shell 22 against external surface 16 of T-rails 18. Thus, track mount 10 is locked in position on T-slot channel 12 until released, for example, by rotation (arrow 36) of coupler 24 in a second releasing direction opposite from the first clamping direction.

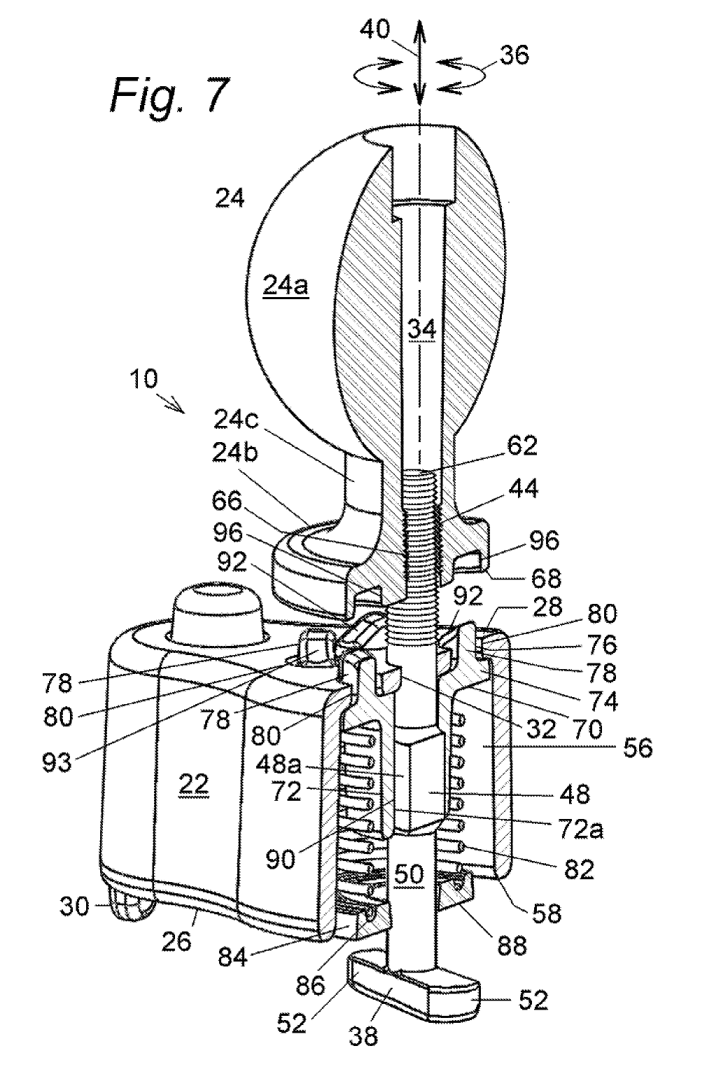

FIG. 7 is a cross-section that illustrates assembly of track mount 10. T-bolt cylinder 70, biasing member 82 and bedding member 84 are inserted into hollow internal cavity 56 of case shell 22 through opening 58 in base 26, individually or in partial or complete assembly. Alignment flange portion 74 of T-bolt cylinder 70 is formed with a shaped complementary to internal cavity 56 of case shell 22, such that control channel 72 is substantially automatically aligned with aperture 32 through crown 28 of case shell 22 along operational axis 34, while anti-rotation interface 76 is substantially automatically aligned between flange portion 74 of T-bolt cylinder 70 and crown 28 of case shell 22. Accordingly, mating teeth 78 and receivers 80 of detent-type anti-rotation interface 76 substantially automatically align between flange portion 74 of T-bolt cylinder 70 and crown 28 of case shell 22. Here, teeth 78 of detent-type anti-rotation interface 76 are shown extended from flange portion 74 of T-bolt cylinder 70 toward being received into mating receivers 80 formed in crown 28 of case shell 22. However, it will be understood that different configurations of anti-rotation interface 76 are also contemplated and may be included and/or substituted without deviating from the scope and intent of the present invention.

T-bolt anchor 38 is assembled into track mount 10 by insertion of threaded shank 62 into control channel 72 of T-bolt cylinder 70. Threaded shank 62 is translated linearly (arrow 40) along axis 34 and outwardly of control channel 72 of T-bolt cylinder 70 past alignment flange 74. Stock portion 48 of T-bolt anchor 38 is translated linearly (arrow 40) into mating alignment with control channel 72 of T-bolt cylinder 70 for forming anti-rotation interface 90 between

T-bolt anchor 38 and T-bolt cylinder 70. Threaded shank 62 of T-bolt anchor 38 is extended through aperture 32 of case shell 22 and extended outwardly of crown 28 thereof.

Coupler actuator 24 is fitted over T-bolt anchor 38, and internal bore 66 interfaces with threaded shank 62. Anti-rotation interface 90 between T-bolt anchor 38 and T-bolt cylinder 70 operates in conjunction with anti-rotation interface 76 between flange portion 74 of T-bolt cylinder 70 and crown 28 of case shell 22 to resist rotation of T-bolt anchor 38 relative to case shell 22. Accordingly, coupler actuator 24 is threaded onto T-bolt anchor 38 without relative turning of T-bolt anchor 38, for example by rotation of head member 24a. Therefore, T-bolt anchor 38 remains effectively aligned with T-slot channel 12 such that flukes 52 remain in contact with T-rails 18 during tightening operation of drive mechanism 44 for clamping track mount 10 onto mounting surface 16 of T-slot 12. Anti-rotation interface 90 similarly resists rotation of T-bolt anchor 38 during loosening operation of drive mechanism 44 for releasing clamping of track mount 10 from T-slot 12.

As disclosed herein, T-bolt anchor 38 is inserted into opening 14 until flukes 52 are in lengthwise cavity 13 between T-rails 18. Then, coupler actuator 24 is operated (arrow 36) as the drive actuator for forcing translation of anchor 38 linearly (arrow 40) along axis 34 against resistance of biasing member 82 and translation of flukes 52 into clamping contact with T-rails 18 of T-slot channel 12, until base 26 of case shell 22 is clamped against external mounting surface 16 of T-rails 18.

Optionally, an anti-actuation interface 94 is provided between drive mechanism 44 and T-bolt cylinder 70 of track mount 10 resisting operation of drive mechanism 44. Here, by example and without limitation, anti-actuation interface 94 is provided by one or a plurality of detents formed between T-bolt cylinder 70 and the drive actuator (coupler 24). In particular, such detent-type anti-actuation interface 94 optionally includes one or more of mating teeth 78 and receivers 96 distributed between T-bolt cylinder 70 and base member 24b of coupler 24. Receivers 96 are recessed into interface surface 68 on bottom of coupler base member 24b.

As illustrated hereinafter, a number of flats 98 are distributed on interface surface 68 of coupler base member 24b between receivers 96 of anti-actuation interface 94. Accordingly, anti-actuation interface 94 operates by receiving different ones of teeth 78 of T-bolt cylinder 70 through receivers 80 in crown 28 of case shell 22 and into receivers 96 in coupler base member 24b. Thereafter, coupler 24 cannot rotate relative to case shell 22. Coupler 24 can only be rotated when teeth 78 are removed from receivers 96, i.e., by being recessed into receivers 80 in crown 28 of case shell 22.

As illustrated here, detent-type anti-actuation interface 94 is optionally formed as a ratchet, wherein teeth 78 are formed with an optional beveled lead-in surface 92 on one facet, while opposite blocking faces of teeth 78 are formed with upright blockading facets 93. Therefore, once coupler base member 24b rotationally interfaces with teeth 78 projecting through exterior surface of crown 28 of T-clamp case shell 22, teeth 78 enter into receivers 96, which effectively stops further relative rotation of coupler actuator 24.

However, after coupler base member 24b rotationally interfaces with projecting teeth 78, continued rotation of coupler actuator 24 is possible by depressing teeth 78 into receivers 80 in crown 28 of case shell 22. Such depressing of teeth 78 is permitted by rotation of coupler actuator 24 in the direction of beveled lead-in surfaces 92 of teeth 78, whereby engagement with flats 98 between receivers 96 depresses teeth 78 against resistance of biasing member 82. Loosening rotation of drive mechanism 44 for releasing clamping of track mount 10 from T-slot 12 is prevented by interference of upright blockading faces 93 on opposite faces of teeth 78. Thus, only tightening rotation of drive mechanism 44 is possible for clamping track mount 10 onto mounting surface 16 of T-slot 12. Anti-actuation interface 94 is thus directional by permitting rotation of coupler actuator 24 in the direction of beveled lead-in surfaces 92 of depressibly projecting teeth 78, while upright blockading faces 93 of teeth 78 block opposite loosening rotation. Directional anti-actuation interface 94 thus operates in the manner of a ratchet mechanism, with depressibly biased teeth 78 operating as the pawl, for preventing reverse rotation of coupler actuator 24 against blockading faces 93 of teeth 78, and loosening rotation of drive mechanism 44.

According to one alternative embodiment, teeth 78 of detent-type anti-actuation interface 94 are optionally formed with upright blockading facets 93 on both clockwise and anticlockwise rotational directions (arrow 36) of coupler actuator 24 about axis 34. Thus, one of upright blockading facets 93 is substituted for optional beveled lead-in surface 92 on one facet of teeth 78. Accordingly, once coupler base member 24b rotationally interfaces with teeth 78 projecting through exterior surface of crown 28 of T-clamp case shell 22, teeth 78 enter into receivers 96, which effectively stops further relative rotation of coupler actuator 24. Thereafter, continued rotation of coupler actuator 24 is possible only by release of anti-actuation interface 94, as disclosed herein at FIG. 11. Release of anti-actuation interface 94 is accomplished by depressing teeth 78 into receivers 80 in crown 28 of case shell 22. Such depressing of teeth 78 is disclosed herein below.

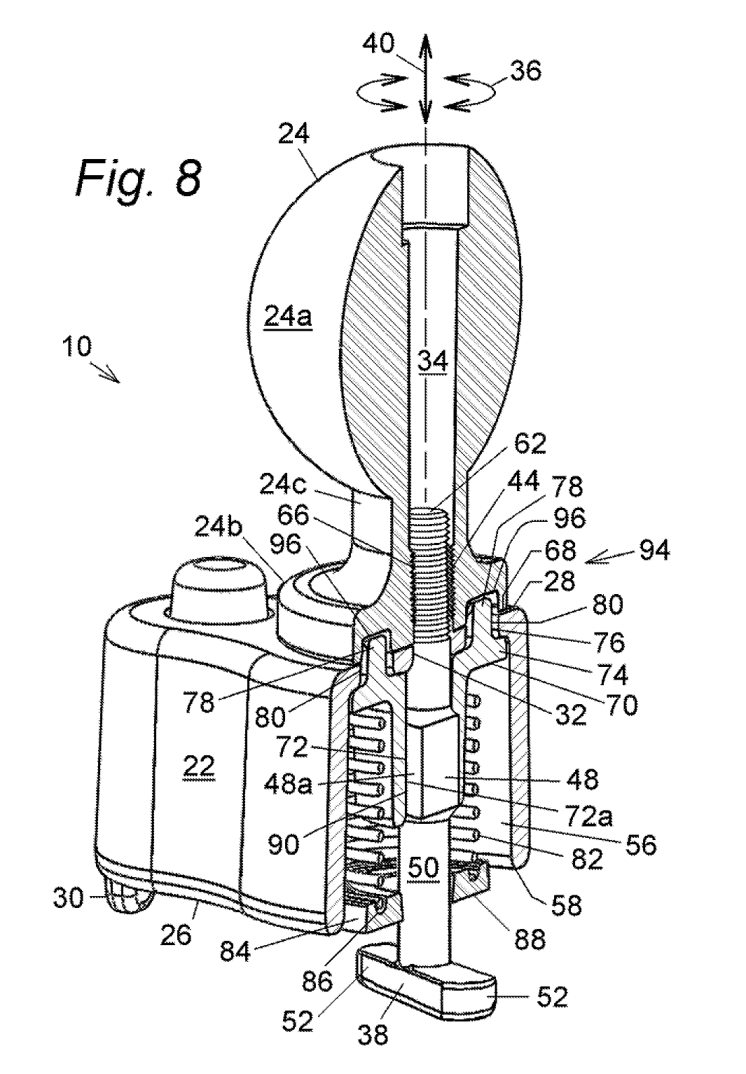

In FIG. 8, after actuator base member 24b rotationally interfaces with exterior surface of crown 28 of T-clamp case shell 22, operation of the drive actuator by continued turning of coupler actuator 24, operates drive mechanism 44 between coupler 24 and T-bolt anchor 38 for drawing T-bolt anchor 38 deeper into track mount assembly 10.

As illustrated here, sloping lead-in surface 92 on one face of teeth 78 of detent-type directional anti-actuation interface 94 permit continued rotation of coupler actuator 24 when base member 24b rotationally interfaces with exterior surface of crown 28 of T-clamp case shell 22.

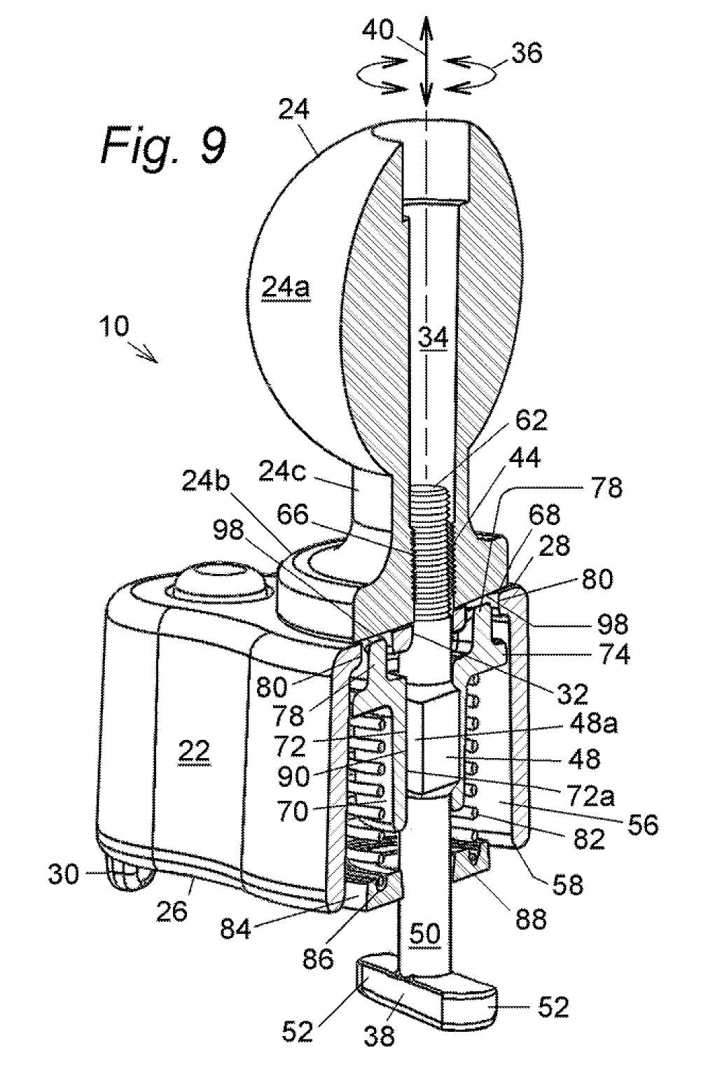

FIG. 9 illustrates the ratchet design of detent-type anti-actuation interface 94 permits operation of drive actuator (coupler 24) for tightening of anchor flukes 52 within T-slot 12, while retaining the clamped configuration after track mount assembly 10 is tightly seated on mounting surface 16 of T-slot 12.

As illustrated here, a number of flats 98 are distributed on interface surface 68 of coupler actuator 24 between receivers 80 of anti-rotation interface 76. As illustrated here, rotation of drive actuator (coupler 24) rotates flats 98 between receivers 80 into contact with sloping lead-in surfaces 92 on teeth 78 such that teeth 78 are compressed into receivers 80, whereby teeth 78 recede into crown 28 of T-clamp case shell 22. Biasing member 82 is simultaneously compressed between shoulder 74 of T-bolt cylinder 70 and bedding member 84 such that biasing member 82 urges T-bolt cylinder 70 toward crown 28 of case shell 22. Accordingly, when continued operation of drive actuator (coupler 24) rotates flats 98 past receivers 80, receivers 96 of coupler base member 24b are rotated into communication with receivers 80 in crown 28 of case shell 22. Teeth 78 are then expanded into receivers 96 of coupler base member 24b by expansion of biasing member 82 between shoulder 74 of T-bolt cylinder 70 and bedding member 84, as illustrated in FIG. 8. Intersection of receivers 96 in coupler base member 24b with receivers 80 in crown 28 of case shell 22 thereby actuates directional detent-type anti-actuation interface 94 for rotationally fixing coupler 24 relative to crown 28 of T-clamp case shell 22.

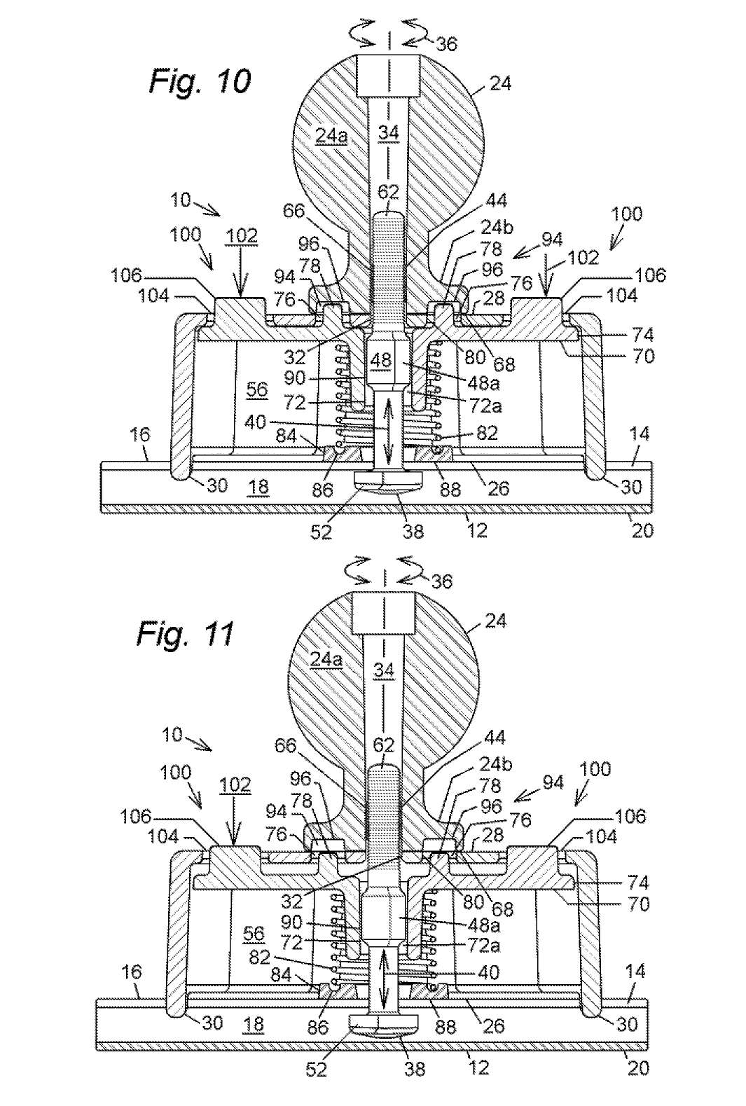

FIG. 10 and FIG. 11 are lengthwise cross-sections showing track mount assembly 10 tightly seated on surface 16 of T-slot 12, wherein FIG. 10 illustrates directional anti-actuation interface 94 being actuated for rotationally fixing drive actuator 24 relative to device case shell 22, and FIG. 11 illustrates directional anti-actuation interface 94 being released.

Release of anti-actuation interface 94 is accomplished by means of a momentary release mechanism 100 which is operable for momentarily releasing anti-actuation interface 94 between coupler actuator 24 and T-bolt cylinder 70. Release of anti-actuation interface 94 is effective for as long as momentary release mechanism 100 is actuated.

Momentary release mechanism 100 is operated, for example, by depressing T-bolt cylinder 70 within cavity 56 of case shell 22 linearly along (arrow 40). As illustrated in FIG. 11, T-bolt cylinder 70 is depressed sufficiently to position teeth 78 in receivers 80 spaced away from interface surface 68 of base member 24b of coupler actuator 24. Teeth 78 projected from shoulder 74 of T-bolt cylinder 70 are thus separated from receivers 96 in base member 24b of coupler actuator 24. Such depression of T-bolt cylinder 70 within cavity 56 of case shell 22 is accomplished, by example and without limitation, by applying a depressing force 102 to T-bolt cylinder 70, for example, through one or more apertures 104 formed through crown 28 of T-clamp case shell 22 and communicating with shoulder 74 of T-bolt cylinder 70. Here, for example, T-bolt cylinder 70 is formed with at least one (two shown) depressors 106 projected from cylinder shoulder 74 in positions for projecting through corresponding apertures 104 through crown 28 of T-clamp case shell 22. Accordingly, depressing force 102 is readily applied to T-bolt cylinder 70 by pushing depressors 106 into corresponding apertures 104 against resilient biasing force of biasing member 82. Accordingly, with anti-actuation interface 94 momentarily released, coupler actuator 24 can be rotated (arrow 36) about axis 34 to operate drive mechanism 44 in the second opposite direction for driving linear translation (arrow 40) T-bolt anchor 38 responsively along axis 34 in a direction for releasing clamping contact of anchor 38 with T-rails 18 of T-slot channel 12. When clamping contact of anchor 38 with T-rails 18 is thus released, track mount 10 can be slidingly moved (arrow 43) along opening 14 of T-slot channel 12, while pair of stabilizers 30 slide along opening 14 in T-slot channel 12; or track mount 10 can be removed entirely from T-slot channel 12.

While the preferred and additional alternative embodiments of the invention have been illustrated and described, it will be appreciated that various changes can be made therein without departing from the spirit and scope of the invention. Therefore, it will be appreciated that various changes can be made therein without departing from the spirit and scope of the invention. Accordingly, the inventor makes the following claims.

What is claimed is:

1. A locking rail base, comprising:
a case comprising a shell forming a hollow cavity and having an opening thereinto, a stabilizer, and a passage through an end of the shell opposite of the opening thereinto;
a T-bolt anchor comprising a shank having flukes adjacent to an end thereof;
a T-bolt cylinder within the cavity in the shell, the T-bolt cylinder comprising a channel having the shank of the T-bolt anchor received slidingly therein;
an anti-rotation interface between the T-bolt anchor and the T-bolt cylinder;
a drive interface between a drive actuator and a portion of the T-bolt anchor;
an anti-actuation interface between the drive actuator and the T-bolt anchor; and
a momentary release mechanism operable for momentarily releasing the anti-actuation interface between the drive actuator and the T-bolt anchor.

2. The locking rail base of claim 1, wherein the shank of the T-bolt anchor is further slidingly receivable into the channel of the T-bolt cylinder in a plurality of different orientations therewith.

3. The locking rail base of claim 1, wherein the anti-rotation interface further comprises mating non-round shapes cooperating between the shank of the T-bolt anchor and the channel of the T-bolt cylinder.

4. The locking rail base of claim 1, wherein the drive actuator further comprises a coupler mounted externally on the shell of the case.

5. The locking rail base of claim 1, wherein the drive interface further comprises a threaded interface between the drive actuator and the shank of the T-bolt anchor.

6. The locking rail base of claim 1, wherein the anti-actuation interface further comprises a detent operational between the drive actuator and the T-bolt cylinder.

7. The locking rail base of claim 6, wherein the anti-actuation interface further comprises one or more mating teeth and receivers distributed between the drive actuator and the T-bolt cylinder.

8. The locking rail base of claim 1, wherein the momentary release mechanism further comprises a means for separating the T-bolt cylinder and the drive actuator.

9. A locking rail base, comprising:
a case comprising a shell forming a hollow cavity therein with a passage through a crown of the shell opposite of an opening thereinto, and comprising a means for stabilizing the shell;
a T-bolt anchor comprising a shank having flukes adjacent to an end thereof;
a T-bolt cylinder positioned within the cavity in the case, the T-bolt cylinder comprising a channel aligned with the passage through the crown of the shell of the case, with the shank of the T-bolt anchor slidable within the channel;
an anti-rotation means for rotationally fixing the shank of the T-bolt anchor about an axis of the channel of the T-bolt cylinder;
an actuation means coupled for translating the shank of the T-bolt anchor along the channel of the T-bolt cylinder;
an anti-actuation means coupled for resisting operation of the actuation means; and
a releasing means coupled for nullifying the anti-actuation means.

10. The locking rail base of claim 9, wherein the anti-rotation means for rotationally fixing the shank of the T-bolt anchor about an axis of the channel of the T-bolt cylinder further comprises a means for rotationally fixing the shank of the T-bolt anchor in a plurality of different rotational orientations with the channel of the T-bolt cylinder relative to the axis thereof.

11. The locking rail base of claim 9, wherein the actuation means further comprises a rotary actuation means coupled for rotationally driving a translation of the shank of the T-bolt anchor along the channel of the T-bolt cylinder.

12. The locking rail base of claim 9, wherein the anti-actuation means further comprises a means for coupling a decoupleable detent between the actuation means and the T-bolt anchor.

13. The locking rail base of claim 12, wherein the releasing means further comprises means for momentarily decoupling the decoupleable detent of the anti-actuation means between the actuation means and the T-bolt anchor.

14. The locking rail base of claim 9, wherein the anti-actuation means coupled for resisting operation of the actuation means further comprises a directional anti-actuation means coupled for resisting operation of the actuation means in only a single rotational direction.

15. A locking rail base, comprising:
a case comprising a shell forming a hollow cavity and having a pair of stabilizers projected therefrom adjacent to an opening thereinto, and a passage through a crown of the shell opposite of the opening thereinto;
a T-bolt cylinder slidingly received into the cavity in the case and urged toward the crown thereof, the T-bolt cylinder comprising a channel aligned with the passage through the crown of the shell of the case;
a T-bolt anchor comprising a shank having flukes adjacent to an end thereof, the shank of the T-bolt anchor being slidingly received into the channel of the T-bolt cylinder and extended through the passage through the crown of the shell of the case;
an anti-rotation interface between the shank of the T-bolt anchor and the channel of the T-bolt cylinder;
an actuator positioned externally of the crown of the shell of the case;
a drive interface between the actuator and an end of the T-bolt anchor shank that is extended through the passage through the crown of the shell of the case;
an anti-actuation interface between the actuator and the T-bolt cylinder; and
a momentary release mechanism operable for momentarily releasing the anti-actuation interface between the actuator and the T-bolt cylinder.

16. The locking rail base of claim 15, wherein the shank of the T-bolt anchor is further slidingly receivable into the channel of the T-bolt cylinder in a plurality of different rotational orientations therewith.

17. The locking rail base of claim 15, wherein the anti-rotation interface between the shank of the T-bolt anchor and the channel of the T-bolt cylinder further comprises mating non-round shapes cooperating between the shank of the T-bolt anchor and the channel of the T-bolt cylinder.

18. The locking rail base of claim 15, wherein the drive interface further comprises a threaded joint between the actuator and the shank of the T-bolt anchor.

19. The locking rail base of claim 15, wherein the anti-actuation interface further comprises a detent operational between the actuator and the T-bolt cylinder, the detent comprising a plurality of teeth extending from the T-bolt cylinder and a plurality of mating receivers formed in an interface surface of the actuator.

20. The locking rail base of claim 15, wherein the momentary release mechanism further comprises a means for momentarily separating the actuator and the T-bolt cylinder.
